(19) United States
(12) Patent Application Publication
(10) Pub. No.: US 2011/0153380 A1
(43) Pub. Date: Jun. 23, 2011

(54) METHOD AND SYSTEM OF AUTOMATED APPOINTMENT MANAGEMENT

(75) Inventor: Umashankar Velusamy, Tampa, FL (US)

(73) Assignee: VERIZON PATENT AND LICENSING INC., Basking Ridge, NJ (US)

(21) Appl. No.: 12/645,063

(22) Filed: Dec. 22, 2009

(51) Int. Cl. G06Q 10/00; G06Q 50/00; G06F 15/16

(52) U.S. Cl. 705/7.19; 709/206

(57) ABSTRACT

An approach is provided for presenting video assets. A first appointment message from a first service provider system relating to a first appointment with a user is received. Also, a second appointment message from a second service provider system relating to a second appointment with the user. A first calendar entry is generated in response to the first appointment message. A second calendar entry is generated in response to the second appointment message. User profile information corresponding to the user is retrieved to determine one or more user devices that are specified to receive the calendar entries.

### BACKGROUND INFORMATION

The tracking of appointments and engagements has become a necessary part of modern living, in both business and personal contexts. Given the ubiquity of mobile computing and communications technologies, users have adopted electronic calendar applications as a replacement for paper-based calendars. These electronic calendar applications have enabled users to accurately manage their appointments (to avoid scheduling conflicts) and to receive alerts of upcoming events. Moreover, users may access their electronic calendars through various devices, e.g., mobile phone, personal digital assistant (PDA), laptop computer, etc. Because calendar applications are local to the particular device, synchronization of calendar entries can be problematic if a user utilizes multiple electronic devices to track appointments. Despite the convenience of the electronic medium, the process of entering appointments is largely manual. That is, the user has to enter the appointment information each time an event is scheduled, as well as the alert setting for the event.

Therefore, there is a need for an approach for automating the scheduling of appointments as well as alert notifications.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A and 1B are, respectively, a diagram of a system capable of providing automated appointment management involving multiple services, and a diagram of a system for providing appointment management across various user devices, according to an exemplary embodiment;

FIG. 2 is a diagram of the automated appointment management platform in the systems of FIGS. 1A and 1B, according to an exemplary embodiment;

FIG. 3 is a flowchart of a process for subscribing to the automated appointment management service, according to an exemplary embodiment;

FIG. 4 is a flowchart of a process for coordinating appointments with various service providers via the automated appointment management platform, according to an exemplary embodiment;

FIG. 5 is a flowchart of a process for parsing appointment messages to generate new appointment entries, according to an exemplary embodiment;

FIG. 6 is a diagram of a set-top box configured to present appointment notifications, according to an exemplary embodiment;

FIGS. 7A and 7B are, respectively, a flowchart of notification process and a diagram of an exemplary user interface of the set-top box of FIG. 6 capable of providing the notification, according to various embodiments; and

FIG. 8 is a diagram of a computer system that can be used to implement various exemplary embodiments.

### DESCRIPTION OF THE PREFERRED EMBODIMENT

A preferred apparatus, method, and system for providing automated appointment management are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect a set-top box (STB), but also have applicability to any device capable of processing audio-video (AV) signals for presentation to a user, such as a home communication terminal (HCT), a digital home communication terminal (DHCT), a stand-alone personal video recorder (PVR), a television set, a digital video disc (DVD) player, a video-enabled phone, an AV-enabled personal digital assistant (PDA), and/or a personal computer (PC), as well as other like technologies and customer premises equipment (CPE).

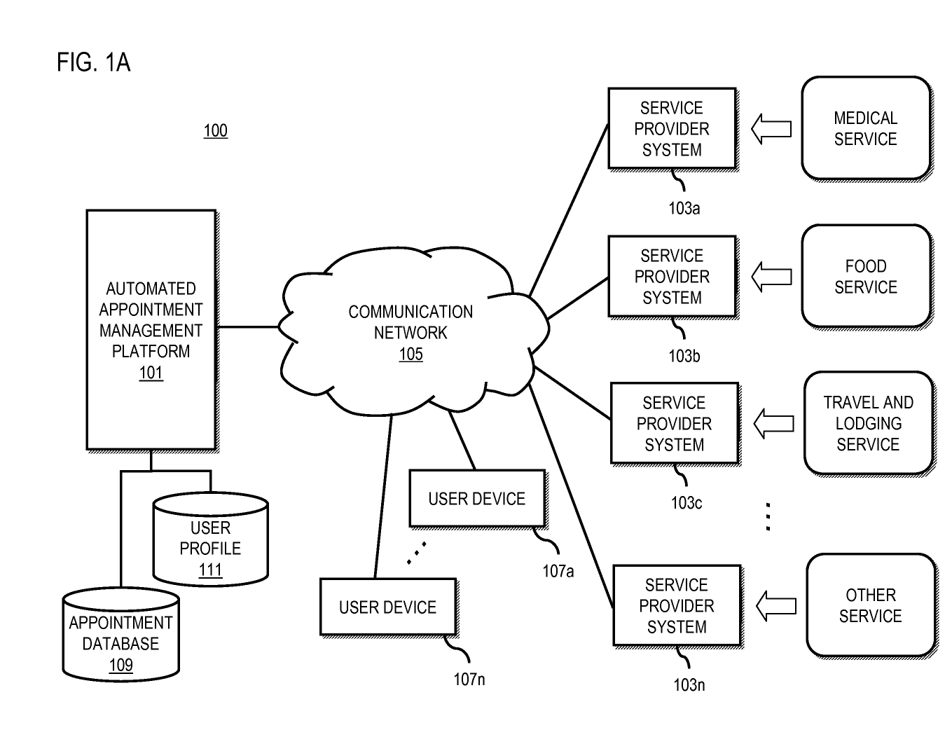

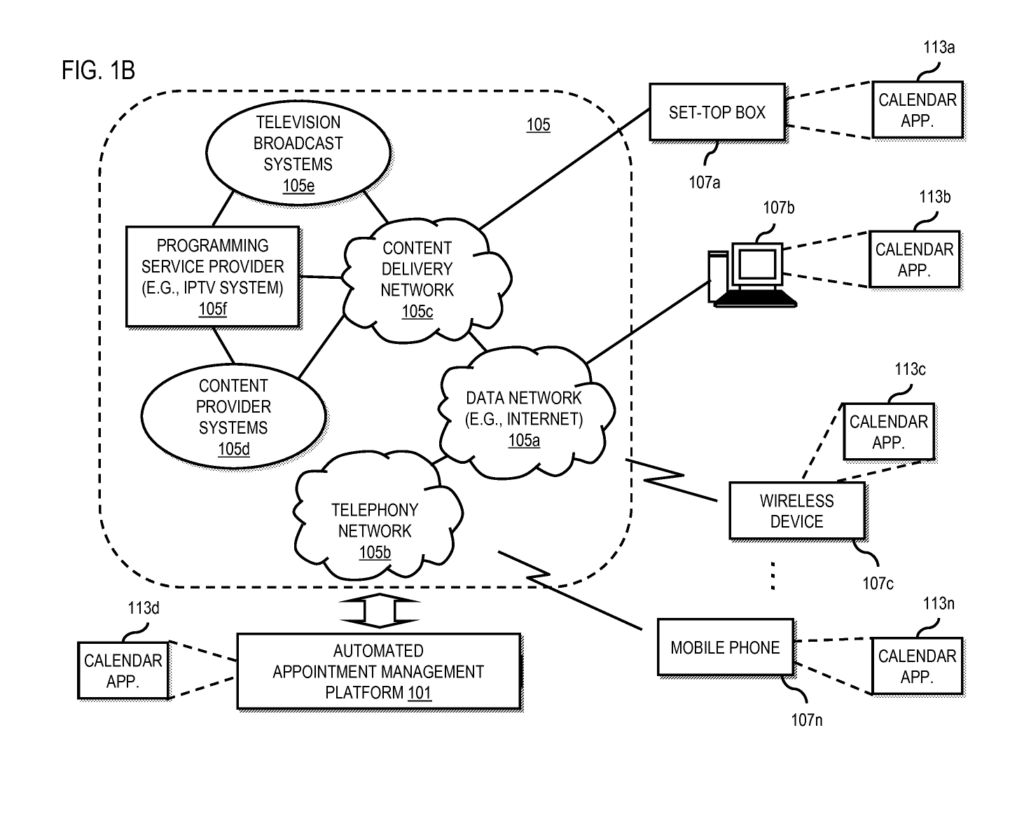

FIGS. 1A and 1B are, respectively, a diagram of a system capable of providing automated appointment management involving multiple services, and a diagram of a system for providing appointment management across various user devices, according to an exemplary embodiment. It is recognized that users typically schedule appointments, meetings, or events with a multitude of service providers conducting various activities. As used herein, service providers refer to providers of any type of services, e.g., airline service, a medical service, a food service, or a lodging service. When the appointment is scheduled, in order for the user to set up the reminder for the appointments, the user has to manually add alerts to the electronic calendar. The particular service provider will also be able to set an alert within its system, and send an alert to the user if the user provides the relevant information to the service provider system (for example, flight delay notifications transmitted in an email to the user's cell phone).

Traditionally, these service provider systems operate independently and may provide limited integration with the electronic calendar application of the user. Accordingly, the user is constrained to managing appointments using the asset or system where the user has recorded the appointment. In essence, the user must check, with each service provider, for the appointment; also, alerts about an upcoming appointment can range greatly in format and presentation. Further, in the event of appointment cancellations, the user has to manually contact and notify each of the affected service providers that the appointment is being cancelled, or updated.

To address this problem, the system 100 of FIG. 1, according to certain embodiments, employs an automated appointment management platform 101 to provide a managed service (or hosted approach) to coordinate the scheduling of appointments or events across the service provider systems 103a-103n. This platform 101 can optionally enable the service providers to avoid having to maintain a system (either manual or automatic) of its own for alerting the user about an upcoming appointment—after acquiring relevant information such as the choice of the notification medium and a schedule preference relating to the notification (i.e., when the user would like to be notified of the appointment alert). The platform 101 also avoids having the user manually set up a reminder or notification about the appointment. Such notification can be triggered based on one or more user specified criteria. As will be more fully described below, the platform 101 has the capability to provide automated notification based on user specified criteria and/or rules. Consequently, the platform 101 may interact with other system (not shown) to gather data to assess whether these criteria and/or rules are satisfied—e.g., such data can include contextual information regarding the user's location, traffic conditions, etc. The notification can be transmitted over a communication network 105 to the user via of anyone of the user devices 107a-107n); these devices 107a-107n can employ various communication technologies to communicate with network 105. Although shown as a single network 105, this communication network 105 represents, in some embodiments, an interwork of communications systems (as described in FIG. 1B).

Under the scenario of FIG. 1A, the service providers can supply any commercial service requiring the schedule of individuals to receive the services, which can include a medical service, food service, travel and lodging service, as well as other services. These service providers employ service provider systems 103a-103n to communicate with the users or patrons, and to maintain their appointment information. Hence, these systems 103a-103n encompass a communication system (e.g., telephony system, email system, etc.) as well as one or more databases to maintain user information and associated appointment data. In certain cases, the service provider systems 103a-103n can individually be used to provide notifications to the users via user devices 107a-107n using short message service (SMS)/multimedia message service (MMS) messaging, email, etc.

In one embodiment, the service provider systems 103a-103n interface with the automated appointment management platform 101 as part of a subscription service. The integration can be of vary levels, depending on the type of subscription and desired integration (e.g., application programming interfaces (APIs), protocols, standards compliance, etc.). According to one embodiment, the automated appointment management platform 101 can be configured to intercept appointment messages from the particular service provider systems 103a-103n to the user devices 107a-107n. Alternatively, one or more of the service provider systems 103a-103n can utilize electronic calendar applications (e.g., MICROSOFT Outlook, LOTUS Notes, etc.) that are compatible with the automated appointment management platform 101, thereby enabling the exchange of calendar entries and notification configurations.

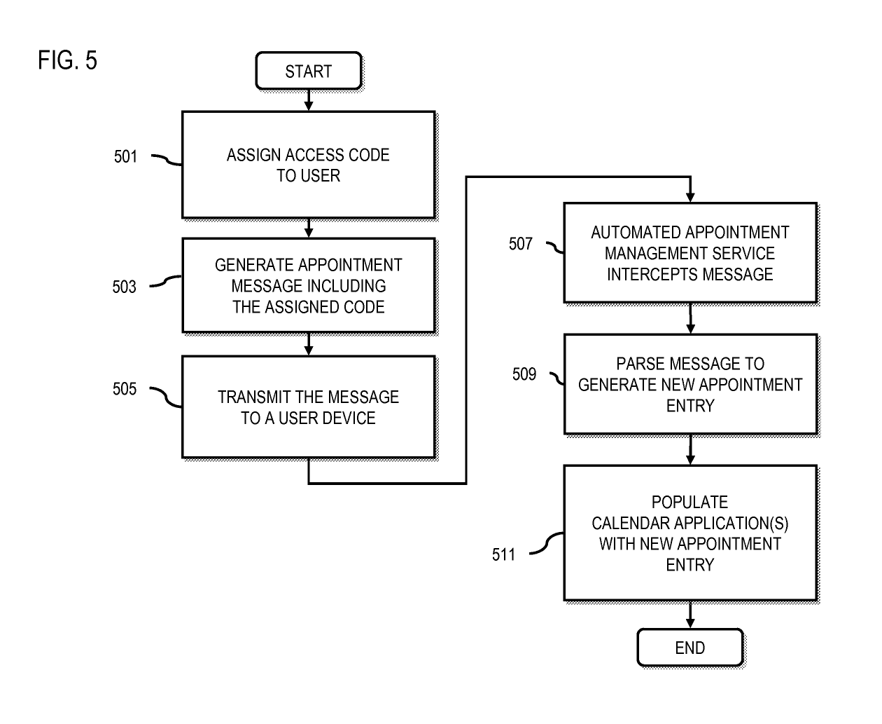

As seen, automated appointment management platform 101 employs an appointment database 109 that can track appointments made from the service provider systems 103a-103n. Further, the platform 101 can maintain a user profile database 111 to store profile information for subscribers to the automated appointment management service; such subscribers can be the end users (associated with user devices 107a-107n) as well as the service providers. For instance, the profile information can specify the user devices designated by a user to receive appointment information and notification. Further, the profile database 111 can store codes that are associated with appointment messages generated by the service provider systems 103a-103n for direct transmission to the user devices 107a-107n. A code can be specified by a user to ensure a level of security when the service provider contacts the user about an appointment. This process is more fully described with respect to FIG. 5.

By way of example, when a user makes an appointment with a service provider (e.g., doctor's appointment) and if the user has subscribed to the notification service of platform 103, the service provider system 103a will automatically notify the automated appointment platform 101. In turn, the platform 101 will automatically create an entry related to the appointment in all of the user's devices (or medium) 105a-105n, including computer, mobile device, set-top box, etc. Under this arrangement, the user can also manipulate the appointments using the user's specified device. The automated appointment platform 101 can also notify the user about the appointment in a pre-set default fashion and based on configuration, additional individuals such as the user's spouse, co-worker, etc. can also be notified of the appointment and the reminders. That is, the user can specify other individuals (and/or their associated devices) that may need to be alerted of the changes to the calendar; these individuals may or may not be subscribers to the platform 101.

Upon receipt of the appointment message, the automated appointment platform 101 automatically generates an appointment entry for addition into the calendar applications of one or more user devices according to information specified in the user's profile. For example, the user profile can indicate user preferences for which user device(s) should be contacted about the new appointment entry—e.g., the user device can be the user cell phone as well as set-top box (STB), as seen in FIG. 1B. Alternatively, users, via devices 107a-107n, may simply interface with the platform 101 to schedule appointments with the participating service providers. This capability may encourage greater participation by service providers, and also minimize the service providers' infrastructure investment.

In certain embodiments, communication network 105 encompasses an interwork of systems, including a data network 105a and/or a telephony network 105b. Additionally, a content delivery network 105c that interacts with one or more content provider systems 105d, television broadcast systems 105e, as well as a programming service provider (e.g., IPTV system) 105f. For example, internet protocol television (IPTV) system can offer subscribers various video services ranging from multi-channel video programming that mimics traditional broadcast television, to true video-on-demand (VOD) programming. These services are further supplemented with interactive video applications that enable robust programming content, selection and navigation functionality, as well as integrated digital video recording, and data services to enhance the video experience. These shared protocols create integrated value propositions with regard to accessible content. By way of example, the programming content available over the content provider network 105c may include any audio-visual content (e.g., broadcast television programs, digital video recorder (DVR) content, on-demand programs, pay-per-view programs, IPTV (Internet Protocol Television) feeds, DVD related content, etc.), pre-recorded media content, data communication services content (e.g., commercials, advertisements, videos, movies, songs, audio books, etc.), Internet-based content (e.g., streamed video, streamed audio), and/or any other equivalent media form.

Programming service provider 105f can provide content that is retrieved over the data network 105a, as well as provide conventional media streams. For instance, programming service provider 105f may provide “virtual channels” to content traditionally limited to host sites, such as end user originated content uploaded to audio, video, and/or pictographic sharing sites. Additionally, the programming content may include streamed audio and/or video from conventional broadcast providers. It is noted that programming content can be any type of information provided from any source having connectivity to network 105.

The systems of network 105 can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., a Verizon® FiOS® network, a TiVo network, etc.), and the like. Such networks may also utilize any suitable protocol supportive of data communications, e.g., transmission control protocol (TCP), internet protocol (IP), file transfer protocol (FTP), telnet, hypertext transfer protocol (HTTP), asynchronous transfer mode (ATM), socket connections, Ethernet, frame relay, and the like, to connect STBs 103a-103n to various sources of media content. Although depicted in FIG. 1B as separate networks, data network 105a and/or telephony network 105b may be completely or partially contained within content delivery network 105c. For example, network 105c may include facilities to provide for transport of packet-based and/or telephony communications.

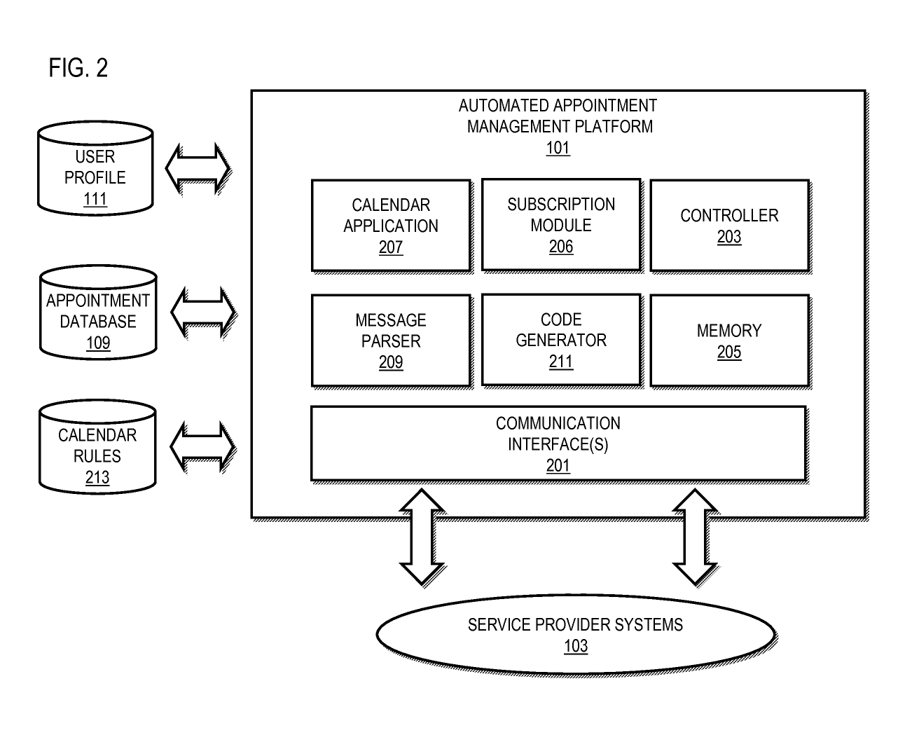

As seen in FIG. 1B, user device 107a is a set-top box that is configured to present calendar data (e.g., appointments and notifications). Alternatively, the STB 107a may execute a calendar application, and thus, can directly communicate with the platform 101 to obtain appointment information and associated alerts. Also, user devices 107b-107n can include a computing device, a wireless device, and a telephony device (e.g., mobile phone), for example. Each of these devices 107b-107n can also configured to execute a local calendar application. By way of example, computer devices may include desktop computers, notebook computers, servers, terminal workstations, gaming systems, customized hardware, or other equivalent apparatus. Telephony devices may comprise plain-old-telephones, wireless telephones, cellular telephones, satellite telephones, voice over internet protocol telephones, and the like. Mobile devices may include personal digital assistants (PDA), pocket personal computers, smart phones, tablets, handsets, portable gaming systems, and customized hardware, as well as other mobile technologies capable transmitting data. According to certain embodiments, these user devices 107a-107n (without maintaining a “full version” (i.e., with limited functionality) of a calendar application, or with no calendar application) can simply receive appointment information and notifications (reminders) of appointments by a calendar application 113d resident on the automated appointment management platform 101. Alternatively, the centralized or hosted calendar application 113d can coordinate electronic invitations for appointments among the calendar applications 113a-113n. In this manner, the platform 101 can resolve potential scheduling conflicts among the service providers for a particular user. Such conflict resolution, in certain embodiments, can be performed using a rules-based approach; for example, a user can specify (as part of the user's profile information) that a medical appointment is of higher priority than a hair appointment, and thus, this prioritization be reflected in one or more rules governing the scheduling of appointments. This approach is more fully detailed below with respect to FIG. 2.

By way of example, STB 107a, as well as other devices 107b-107n, can remotely access via a communication interface (not illustrated) platform 101, which is configured to execute multiple instances of a calendar application. That is, calendar application may be provided in a distributed fashion using, for instance, client-server architectures, such as implemented by enterprise application service providers (ASP). It is noted that ASP models (and other like architectures) offer system scalability in terms of administrative scalability, geographic scalability, and/or load scalability. Thus, distributed environments are attractive modes for disseminating system functionality to a broad spectrum of users and devices.

Exemplary embodiments of calendar application 113 may comprise hypertext markup language (HTML) user interfaces or JAVA™ applets stored on within platform 101 and accessed via world-wide-web pages. These interfaces are particularly useful in extending the automated appointment management platform's functionality to devices having limited resources (e.g., PDAs, handsets, thin-clients, etc.). In alternative embodiments, platform 101 is collocated with and/or integrated into programming service provider 105f. As such, multiple users, interfaces, and instances of calendar application 113d can be simultaneously realized through system 101.

Programming service provider 105f can include one or more programming content servers (not illustrated) and/or data repositories (not shown). In one embodiment, the user profile repository 111 stores user settings, preferences, and configuration information for the calendar application 113.

In an exemplary embodiment, STB 107a can draw, receive, and/or transmit programming guide information and related content from (or to) multiple sources, thereby alleviating the burden on any single source, e.g., programming service provider 105f, to gather, supply, or otherwise meet the content demands of any user or premise. Thus, particular embodiments enable authenticated third-party television broadcast systems 105e, third-party content provider systems 105d, and content servers (not shown) to transmit programming content accessible over network 105 to STB 107a either apart from, or in conjunction with, programming service provider 105f. Such programming content may include the calendar information (e.g., appointments and associated reminders and notifications) as well as content regarding traffic, news, sports, current events, breaking stories, commentary, headlines, advertisements, solicitations, financial advice, stocks, markets, events, schools, governments, blog entries, podcasts, and the like. Moreover, media content may be available from authenticated sources, including grassroots groups or individuals, non-profits, governmental organizations, public/private institutions, etc.

In various embodiments, content delivery network 105c may include one or more video and/or audio processing modules (not shown) for acquiring and transmitting programming guide information and related content feeds (including content accessible over a data network) from programming service provider 105f, the television broadcast systems 105e, the third-party content provider systems 105d, or the content servers. Accordingly, content delivery network 105c may include facilities to support compression/decompression, coding/decoding, modulation/demodulation, optical/electrical conversion, and analog/digital conversion, as well as any other suitable signal processing and/or transmission operation. Further, content delivery network 105c can optionally support end-to-end data encryption in conjunction with programming guide creation and related content streaming services such that only authorized users are able to access personalized programming guides and experience content reference therein.

It is noted that the exemplary components of FIGS. 1A and 1B are not intended to be limiting, and indeed, additional or alternative components and/or implementations may be utilized.

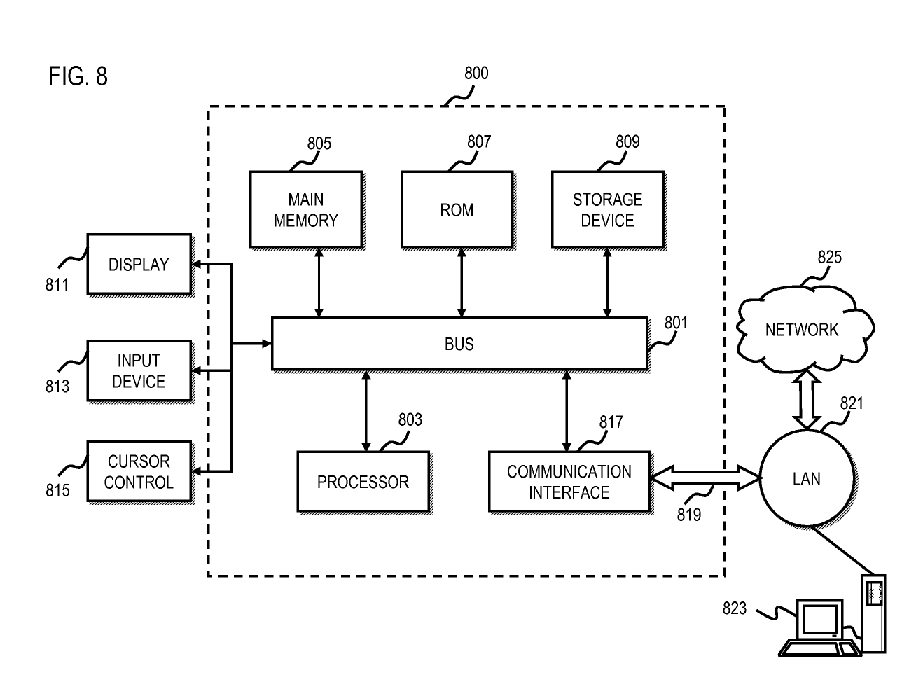

FIG. 2 is a diagram of the automated appointment management platform in the systems of FIGS. 1A and 1B, according to an exemplary embodiment. Automated appointment management platform 101 may comprise computing hardware (such as described with respect to FIG. 8), as well as include one or more components configured to execute the processes described herein. In one implementation, platform 101 includes communication interface 201, one or more controllers (or processors) 203, one or more memories 205, a subscription module 206, a calendar application 207, a message parser 209, and a code generator 211. Platform 101 may also communicate with one or more repositories, such user profile repository 111, appointment database 109, and a calendar rules database 213. Users may access platform 101 (or the features and functionality provided thereby) via the user devices 107a-107n. While specific reference will be made to this particular implementation, it is also contemplated that platform 101 may embody many forms and include multiple and/or alternative components. For example, it is contemplated that the components of platform 101 may be combined, located in separate structures, or separate locations.

According to one embodiment, platform 101 embodies one or more application servers accessible to user devices 107a-107n over network 105. Users (or subscribers) can access platform 101 to create, customize, and manage one or more user profiles in support of the automated appointment management service. User profile information can include the devices that the subscriber is designating as participating in the service, as well as individuals who are to be additionally notified of calendar changes (along with the contact information of these individuals—e.g., email address, telephone number, instant messaging identifier, etc.). The profile information can include other information regarding user preferences for the automated appointment management service.

Platform 101 may provide a user interface, e.g., web portal or other networked application, to permit user to access the features and functionality of platform 101 via user devices (e.g., client devices) 107a-107. According to certain embodiments, the platform 101 may be configured for exchanging information between devices 107a-107n and a web browser or other network-based application or system, such as a voice browser or interactive voice recognition system.

In exemplary embodiments, subscription module 206 may be configured to execute one or more GUIs that are configured to provide users with one or more menus of options for creating, customizing, and managing user profiles, as well as engaging with the other features and functionalities of system 100 relating to the automated appointment management service. In this manner, subscription module 206 (via communication interface 201) may be configured to receive requests from both service provider systems 103a-103n and user devices 107a-107n to subscribe to the service. In certain embodiments, subsequent to the subscription process, users may then be authenticated to “logon” to the platform 101.

According to some embodiments, platform 101 includes an authentication module (not illustrated) for authenticating (or authorizing) users to platform 101. An authentication schema may require a user name and password, a key access number, a unique machine identifier (e.g., media access control (MAC) address), etc., as well as a combination thereof. Once a subscriber has authenticated a presence on platform 101, the user may bypass additional authentication procedures for executing later applications. Data packets, such as cookies, may be utilized for this purpose, for example. It is contemplated that the authentication module may operate in concert with communication interface 201. That is, the authentication module may verify user provided credential information acquired via communication interface 201 against corresponding credential information stored within a user profile of, for instance, user profile repository 111. By way of example, the credential information may include “log on” information corresponding to a user name, password, coded key, or other unique identification parameter, such a personal identification number (PIN). In other instances, the credential information may include any one or combination of a birth date, an account number (e.g., bank, credit card, billing code, etc.), a social security number (SSN), an address (e.g., work, home, internet protocol (IP), media access control (MAC), port, etc.), or telephone listing (e.g., work, home, cellular, etc.), as well as any other form of uniquely identifiable datum, e.g., biometric code, voice print, etc. Subscribers may provide this information via user devices 107a-107n such as by spoken utterances, dual-tone multi-frequency (DTMF) signals, packetized transmission, etc., as appropriate. It is contemplated that unobtrusive security may be provided by positively identifying and screening users based on one or more of the aforementioned credentials which may be seamlessly provided when devices 107a-107d communicate with platform 101, such as a unique IP or MAC address. Other unobtrusive measures can be made available via voice prints, etc.

As mentioned, one capability of the platform 101 involves automatically generating a calendar entry when an appointment is scheduled a service provider system (e.g., system 103a). In certain embodiments, message parser 209 is configured to “intercept” an appointment message that is created by the service provider system 103a. The appointment message, which includes time and date of the appointment as well as a description of the appointment, can be in various formats depending on the particular communication technology, e.g., SMS/MMS, instant messaging, email, etc. To ensure an added layer of security, the user can specify a code, which may be any sequence of alphanumeric characters, for the service provider system 103a to include in the appointment message. In the case of a SMS message, this appointment message may be received by user device 107a, which can be configured with an application to notify the platform 101 of the appointment, thereby effectively redirecting the SMS message to the platform 101 for processing by the message parser 209. Upon extracting the appointment information from the message, the parser 209 can relay this data to the calendar application 207 to generate a new appointment entry.

In the event that multiple appointments received from the various service provider systems 103a-103n overlap or otherwise conflict. The calendar application 207 can retrieve rules from calendar rules database 213 to apply. Such rules can be predetermined as part of system default rules by the platform 101, or specified by subscribers as part of their profile information (stored in database 111). These rules can be periodically modified depending on the behavior of specific users or the collective community of users. For example, if it is determined that users tend to cancel hair appointments that conflict with medical appointments (even though the medical appointments were made subsequently), then the platform 101 can “learn” such behavior and adapt the calendar rules accordingly. Additionally, services in which appointments are “hard-to-get” can be prioritized ahead of other services. Such prioritization can be determined during the user registration process, for example.

As shown, code generator 211 can optionally be part of the platform 101, as to permit the platform 101 to automatically learn of the user's code associated with particular service provider systems 103a-103n. The code generator 211 can then store this code information as part of the subscriber's user profile. Alternatively, the subscriber can employ platform 101 to generate the codes. For example, if the different service provider systems 103a-103n employ different communication technologies and/or formats to convey the appointment messages to the user devices 107a-107n, the platform 101 can supply conforming codes to the users. Alternatively, the user can schedule an appointment with a service provider via the platform 101, the automatic generation of the code (e.g., consistent with the user profile information) provides an added level of convenience to the subscriber, in that the subscriber need not separately indicate a code to the service provider to receive an appointment message (indicating the code to the user as part of the security measure).

Additionally, platform 101 may include one or more controllers 203 for effectuating the aforementioned features and functionality of the automated appointment management service, as well as one or more memories 205 for permanent and/or temporary storage of one or more of the aforementioned variables, parameters, information, signals, etc. In this manner, the features and functionalities of calendar application 207 may be executed by controller(s) 203 and/or memories 205, such as in conjunction with one or more of the various components of platform 101.

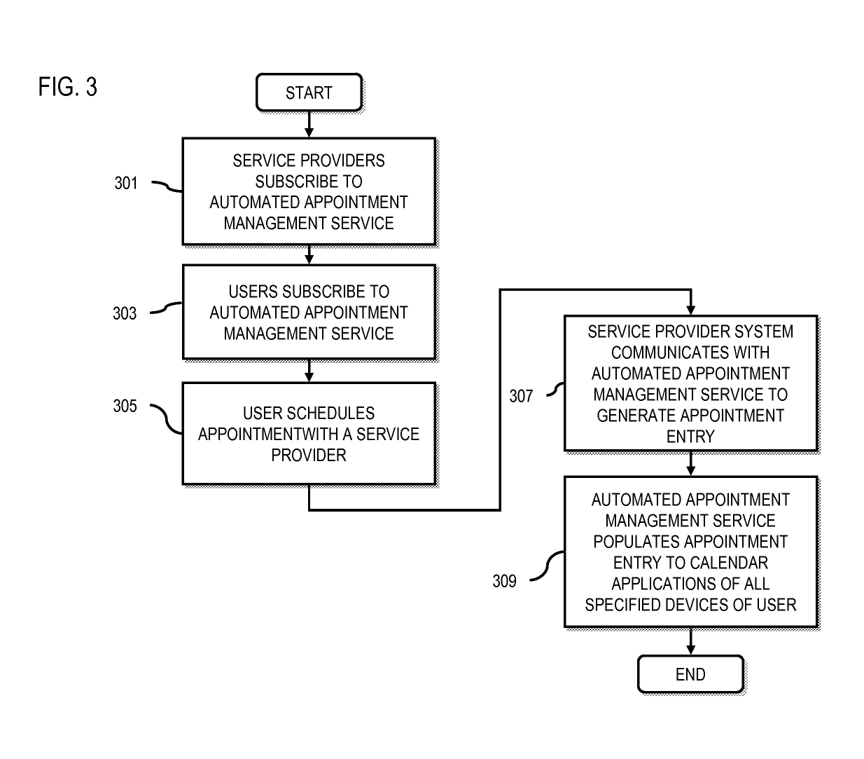

FIG. 3 is a flowchart of a process for subscribing to the automated appointment management service, according to an exemplary embodiment. By way of example, the platform 101 provides the automated appointment manager service as a subscription-based service. Such subscription service can be paid or unpaid (free). Accordingly, per steps 301 and 303, the service providers and end users subscribe to the automated appointment management service via the platform 101; notably via the subscription module 206. Such subscription process can be, for example, a web-based application in which subscribers provide user information and profile data relating to the manner in which appointment information and notifications are processed and delivered.

In step 305, a user schedules an appointment with a service provider. Thereafter, the corresponding service provider system (e.g., 103a) communicates, per step 307, with the platform 101 to generate an appointment entry. As will be later explained, this generation of new appointment entries can be based on appointment messages that are conveyed to the user, rather than direct exchange of information between the service provider system 103a and the platform 101. In step 309, the automated appointment management service populates the appointment entry to calendar applications of the user devices specified by the subscriber.

Once a user has subscribed to the automatic appointment manager service and schedules an appointment of any kind with the participating service providers, the participating service provider will send the relevant details to platform 101 using an agreed upon medium (such as a webservice call) as soon as the appointment is made. It is contemplated that the several service provider systems can utilize different media to receive the appointment information.

As explained earlier, automated appointment management platform 101 can advantageously provide a centralized system for coordinating appointments among the many service providers, thereby permitting users to efficiently manage their appointments.

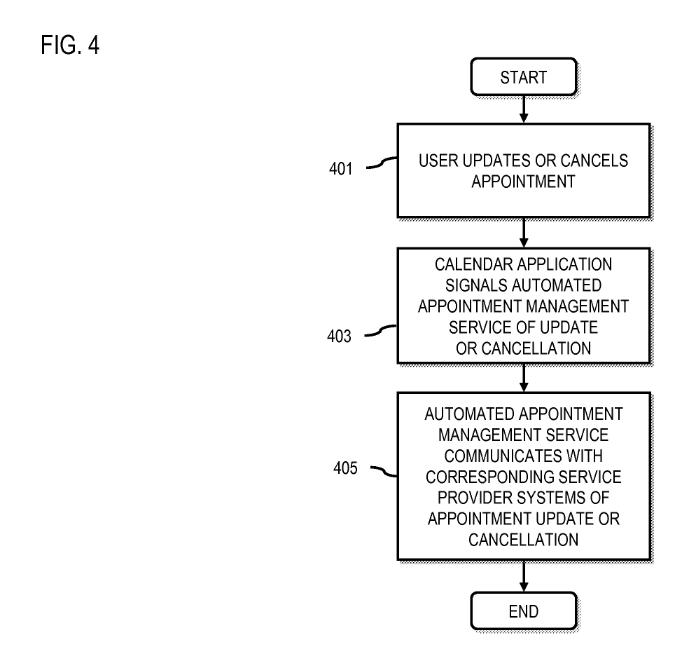

FIG. 4 is a flowchart of a process for coordinating appointments with various service providers via the automated appointment management platform, according to an exemplary embodiment. With the automated appointment platform 101, a user can efficiently and conveniently update or cancel appointments. Under one scenario, the user has scheduled appointments with various service providers; e.g., a meeting with a loan officer in the morning, and a doctor's appointment in the afternoon. Should the user encounter an emergency that requires cancellation (or rescheduling) of the appointments for the day, the user can inform the platform 101 of the update or cancellation request. The platform 101 can in turn notify all the affected service providers about the appointment being cancelled or updated.

In step 401, a user, using STB 103a, can logon to the platform 101 to indicate an update of an appointment (e.g., rescheduled time) or out-right cancellation of the appointment. This update or cancellation request can be made via a local calendar application of STB 103a in communication with the platform 101, or using the hosted calendar application of the platform 101. In step 403, in the case the local calendar application triggers the update or cancellation, this instruction is signaled to the platform 101. It is contemplated that the user can specify cancellation by indicating an interval of unavailability—e.g., a time range (8:00 AM-4:00 PM), or a date range (September 22-October 22), etc. In this way, the platform 101 will convey the cancellation of appointments scheduled during the interval of unavailability to the affected service provider systems 103a-103n (per step 405). The platform 101 can optionally coordinate the rescheduling of such appointments for the user as well.

According to one embodiment, the platform 101 can automatically determine the possibility of cancellation of an appointment; check with the user/designated contact; and cancel or update the appointment. For example, if the user encounters an accident and is admitted to a hospital, and if the hospital is a participating service provider, the platform 101 will automatically recognize the possible appointment cancellations, confirm with the user or the designated contact noted by the user, (notify) and cancel the appointments.

Another advantage of platform 101, according to certain embodiments, is the ability for the user to not have to manually enter appointments. Rather, these appointments can be automatically generated even if the user merely makes an appointment with a service provider using any means—e.g., telephone call, web-based session, etc. These “non-electronic calendar” communications can be converted into electronic calendar entries by the platform 101, as next explained.

FIG. 5 is a flowchart of a process for parsing appointment messages to generate new appointment entries, according to an exemplary embodiment. For the purposes of illustration, this process is described with respect to a medical service, and thus, service provider system 103a. Under this scenario, a user provides a telephone number and access code to a service provider (e.g., a doctor's office), which allows the medical service provider to send an appointment message (e.g., short message service (SMS)/multimedia message service (MMS)) to the user via service provider system 103a. Hence, from the perspective of the service provider system 103a, an access code is assigned to the user, per step 501, and the appointment message is created to include the code (step 503).

In one embodiment, codes can be specific to the user. Also, the code may be a many-time use code, whereby the code is reused any number of times or according to a predetermined amount of times. Further, the codes can be generated for a one-time use; i.e., the code is changed each time an appointment message is sent with a code. In one embodiment, a new code is automatically generated by the platform 101 or at the user device.

The appointment message, as in step 505, is then transmitted to the use device (e.g., one or more of the user devices 107a-107n). User of the access code provides certain security measures, e.g., preventing spamming with appointments on the user's calendar.

For example, the SMS/MMS message destined for user can be intercepted by platform 101 (step 507), thereby triggering an “add to calendar” option for the user. As described, this interception can be an SMS/MMS that is redirected to the platform 101 (as pre-arranged with the user as part of the registration process). By way of example, the appointment message can be sent in a pre-defined format. This message is then parsed, per step 509, by the platform 101 using message parser 209, to generate a new appointment entry. In one embodiment, the new appointment entry is populated in the centralized calendar application 207, per step 511. Alternatively, the new appointment entry is automatically distributed to the user's specified devices for entry into local calendar applications.

One of the devices, as explained earlier, can be a set-top box (STB) 107a. An exemplary scenario of how a STB can be utilized in the automated appointment management service is as follows.

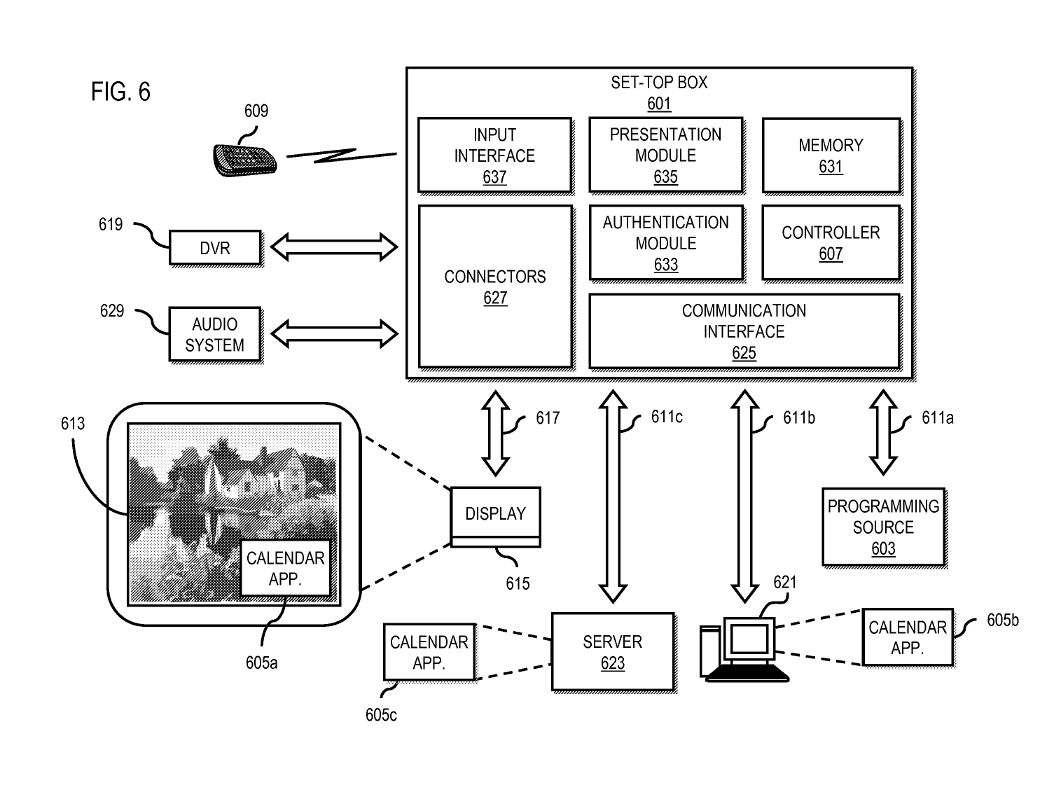

FIG. 6 is a diagram of a set-top box configured to present appointment notifications, according to an exemplary embodiment. STB 601 may comprise any suitable technology to receive one or more content streams (e.g., video assets) from a media source 603, such as the IPTV system of FIG. 1B. The content streams include programming guide information and appointment information and/or associated notifications and reminders retrieved over the network 105, in response to commands from one or more calendar application(s) 605a-605c, for presentation via STB 601. Accordingly STB 601 may comprise computing hardware (such as described with respect to FIG. 8) and include additional components configured to execute an electronic calendar application and/or access the platform 101. In addition, STB 601 includes hardware and/or other components to support related functions and capabilities for viewing video assets (e.g., remote control capabilities, conditional access functions, tuning functions, presentation functions, multiple network interfaces, audio/video signal ports, etc.). As shown in FIG. 6, the functions and operations of STB 601 may be governed by a controller 607 that interacts with each of the STB components to provide programming guide information and related content retrieved from an audio or video-sharing site, as well as from another STB device or component of system 100.

As such, STB 601 may be configured to cause a calendar application 605a and/or one or more components of (e.g., video component 613 and/or an audio component) to be presented on (or at) display 615. Presentation of the graphical user interface of the appointment information and associated notification, video assets and related content may include: displaying, recording, playing, rewinding, forwarding, toggling, selecting, zooming, or any other processing technique that enables users to navigate the programming guide and experience content streams 611a-611c. For instance, STB 601 may provide one or more signals 617 to a display 615 (e.g., television) so that the display 615 may present (e.g., display) a graphical user interface created by the calendar application 605a as an overlay on the programming content (e.g., video 613).

STB 601 may also interact with a PVR, such as digital video recorder (DVR) 619, to store received content that can then be manipulated by a user at a later point in time. In various embodiments, DVR 619 may be network-based, e.g., included as a part of the content delivery network 105c, collocated at a subscriber site having connectivity to STB 601, and/or integrated into STB 601. In alternative embodiments, STB 601 may be configured to communicate with a number of additional peripheral devices, including: a PC 621, laptops, PDAs, cellular phones, monitors, mobile devices, handheld devices, as well as any other equivalent technology capable of presenting programming guide information and related content to a user, such as those computing, telephony, and mobile apparatuses described with respect to FIG. 1B.

By way of example, a programming content stream 611a may be received by STB 601 and recorded by DVR 619, wherein PC 621 may later access and view the stored content. Moreover, the peripheral devices may be configured to program or otherwise control the functions of STB 601. A communication interface (not illustrated) of PC 621 may be configured to retrieve the programming and content information over the data network (e.g., data network 105a), wherein STB 601 may receive a programming content stream 611b from PC 621 to present to the user via display 615.

Still further, user input to a network-based calendar application, implemented on, for instance, server 623, may be configured to create appointments and receive appointments from platform 101.

Furthermore, STB 601 may include a communication interface 625 configured to receive content streams from the programming service provider 105f, PC 621, server 623, or other programming content source, such as media source 603. Communication interface 625 may optionally include single or multiple port interfaces. For example, STB 601 may establish a broadband connection to multiple sources transmitting content to STB 601 via a single port, whereas in alternative embodiments, multiple ports may be assigned to the one or more sources. In still other embodiments, communication interface 625 may be configured to permit users, via STB 601, to transmit data (including media content) to other users with STBs, a programming service provider 105f, or other content source/sink.

According to various embodiments, STB 601 may also include inputs/outputs (e.g., connectors 627) to display 615 and DVR 619, as well as an audio system 629. In particular, audio system 629 may comprise a conventional audio-video receiver capable of monaural or stereo sound, as well as multichannel surround sound. Audio system 629 may include speakers, ear buds, headphones, or any other suitable component configured for personal or public dissemination. As such, STB 601, display 615, DVR 619, and audio system 629, for example, may support high resolution audio and/or video streams, such as high definition television (HDTV) or digital theater systems high definition (DTS-HD) audio. Thus, STB 601 may be configured to encapsulate data into a proper format with required credentials before transmitting onto one or more of the networks of FIG. 1B and de-encapsulate incoming traffic to dispatch data to display 615 and/or audio system 629.

In an exemplary embodiment, display 615 and/or audio system 629 may be configured with internet protocol (IP) capability (i.e., includes an IP stack, or is otherwise network addressable), such that the functions of STB 601 may be assumed by display 615 and/or audio system 629. In this manner, an IP ready, HDTV display or DTS-HD audio system may be directly connected to network 105. Although STB 601, display 615, DVR 619, and audio system 629 are shown separately, it is contemplated that these components may be integrated into a single component, or other combination of components.

An authentication module 633 may be provided at STB 601 to initiate or respond to authentication schemes of, for instance, content delivery network 105c or various other content providers, e.g., broadcast television systems 105e, third-party content provider systems 105d. Authentication module 633 may provide sufficient authentication information, e.g., a user name and password, a key access number, a unique machine identifier (e.g., MAC address), and the like, as well as combinations thereof, to a corresponding network interface for establishing connectivity. As described earlier, one or more digital certificates may be simultaneously mapped. Moreover, authentication at STB 601 may identify and authenticate a second device (e.g., PC 621) communicatively coupled to, or associated with, STB 601, or vice versa. Further, authentication information may be stored locally at memory 631, in a repository (not shown) connected to STB 601, or at a remote repository, e.g., user profile repository 111.

A presentation module 635 may be configured to receive data streams 611a-611c (e.g., audio/video feed(s) including video asset ranking information and related content retrieved over the content delivery network 105c) and output a result via one or more connectors 627 to display 615 and/or audio system 629. In this manner, presentation module 635 may also provide a user interface for calendar application 605a via display 615. Aural aspects of calendar application 605a (e.g., audible alerts and cues) may be presented via audio system 629 and/or display 615. In certain embodiments, calendar application 605a may be overlaid on the video content output 613 of display 615 via presentation module 635.

Connector(s) 627 may provide various physical interfaces to display 615, audio system 629, as well as other peripherals; the physical interfaces may include, for example, RJ45, RJ11, high definition multimedia interface (HDMI), optical, coax, FireWire, wireless, and universal serial bus (USB), or any other suitable connector. The presentation module 635 may also interact with a control device 609 for determining particular media content that a user desires to experience. In an exemplary embodiment, the control device 609 may comprise a remote control (or other access device having control capability, such as a PC 621, wireless device, mobile phone, etc.) that provides a user with the ability to readily manipulate and dynamically change parameters affecting the appointment information for presentation in the graphical user interface. In other examples, STB 601 may be configured for voice recognition such that STB 601 may be controlled with spoken utterances.

In this manner, control device 609 may include (not shown) a cursor controller, trackball, touch screen, touch pad, keyboard, and/or a key pad for activating asset manager application 605a, navigating through the graphical user interface of ranked video assets, selecting programming content, as well as performing other control functions. For instance, control device 609 may be utilized to maximize an asset manager application, navigate through displayable interfaces, specify factors and weighting for ranking video assets, or modify STB 601 parameters. Control device 609 may also include functional actuators (e.g., buttons, keys, icons, etc.), such as power on/of, play, pause, stop, fast-forward, reverse, volume up/down, channel up/down, menu, ok/enter, record, info, my content, search, edit, or exit, as well as any other suitable control trigger, such as alphanumeric buttons, shift, control, back, symbols, and the like.

Further, the control device 609 may comprise a memory (not illustrated) for storing preferences affecting the graphical user interface of calendar information that is being viewed, which can be conveyed to STB 601 through an input interface 637. The input interface 637 may support any type of wired and/or wireless link, e.g., infrared, radio frequency (RF), BLUETOOTH, and the like. Thus, control device 609 may store user preferences with respect to the automated appointment management service, previous searches, recording history, programming preferences, etc. Alternatively, user preferences may be tracked, recorded, or stored in STB 601 or in a network user profile repository 111. The preferences may be automatically retrieved and activated by a user at any time. It is noted that the control device 609 may be separate from STB 601 or may be integrated within STB 601 (in which case certain input interface hardware and/or software may not be necessary).

Particular embodiments enable users, via control device 609, to populate or otherwise configure a user profile. For instance, a user profile application may be provided or accessed by STB 601 to enable users to populate a plurality of entry fields with user information. A user profile may include one or more customized or personalized settings that affect any aspect of creating a personalized graphical user interface of calendar information (e.g., appointment information and notifications) via STB 601.

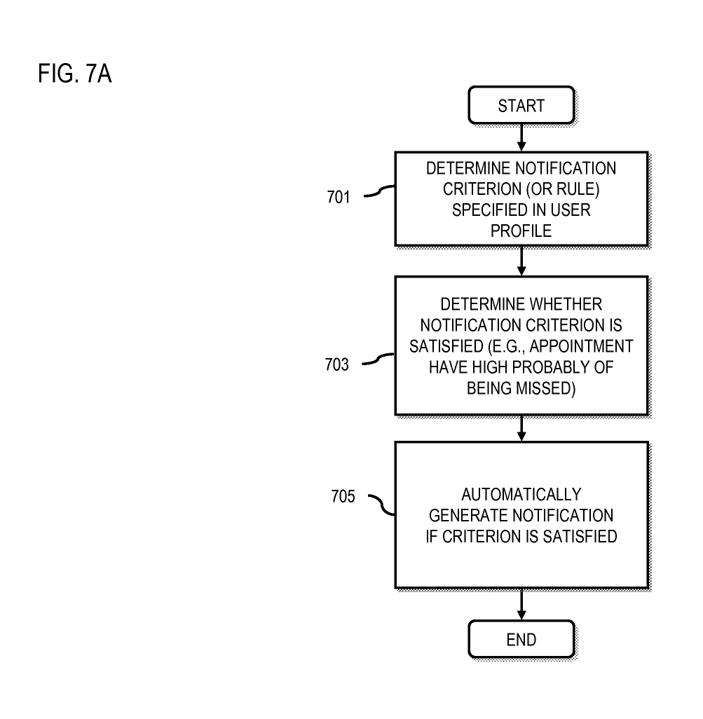

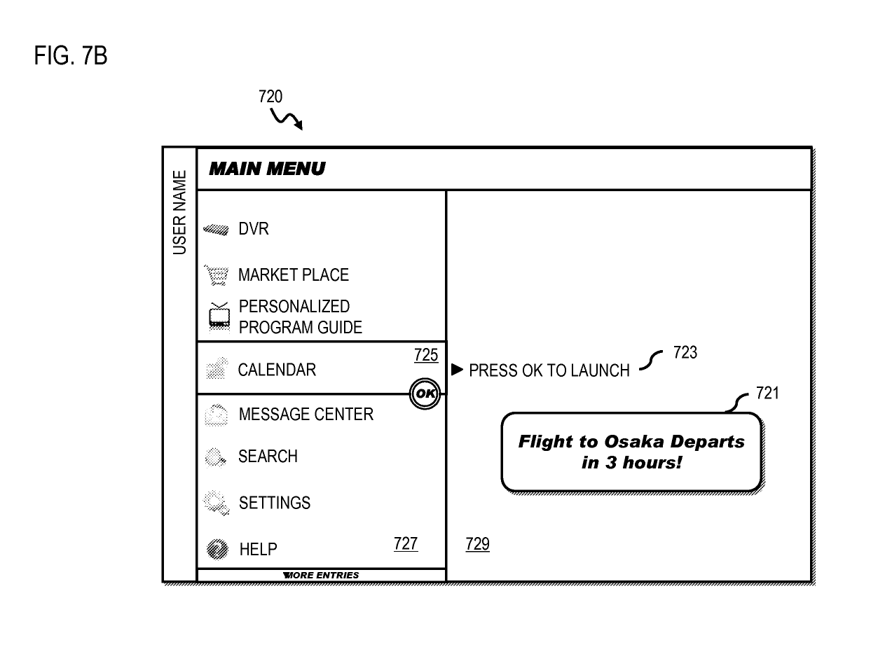

FIGS. 7A and 7B are, respectively, a flowchart of notification process and a diagram of an exemplary user interface of the set-top box of FIG. 6 capable of providing the notification, according to various embodiments. The automated appointment management platform 101 can set a reminder field to generate alerts at a preset time based on the settings in the user's profile. According to one embodiment, the user can modify or alter the settings stored within the platform 101 using any one of the user devices, which for the purposes of explanation, is described with respect to STB 107a. As part of the service for managing appointments, the platform 101 provides a notification service relating to the appointment or event entries. The platform 101 can generate alerts to remind the user of an upcoming appointment, even if the user has not specified or otherwise requested any notifications.

Per FIG. 7A, in step 701, the platform 101 can determine a notification criterion (or rule) specified in the user profile. The criterion, or rule, according to one embodiment, can be based on a multitude of factors relating to the appointment—e.g., the rule may specify that a notification be provided if the appointment is likely to be missed. In other words, if the platform 101 can assess (evaluate) that the appointment may be missed by the user (e.g., due to traffic conditions around the location of the user, for example), an appropriate notification can be transmitted to the user in time for the user to react to this possibility. By way of example, the user is scheduled to depart on an international flight to, e.g., Osaka, Japan. The platform 101 may be aware of the airport traffic conditions, and hence, can factor in such potential delay when generating the notification. In step 703, the process determines whether the notification criterion is satisfied, and automatically generates a notification if the notification criterion is satisfied.

In one embodiment, the notification criteria, more generally, may include a time period that is to be set for the alert; this time period can be based on the type of appointment and/or contextual information (e.g., user location) associated with the user. For example, the time period can a constant period (e.g., 30 minutes before the event) or be in combination with any time delay (e.g., stemming from factors such as traffic conditions, etc.) that is determined by the platform 101. In step 705, the notification is automatically generated based on whether the notification criterion is satisfied.

As another example, if the user has setup a doctor's appointment in which the user forgets about the appointment one hour before the scheduled time (and the user is about an hour away from the destination, or if the traffic between the user's location and the destination is such that transit time would take more than an hour for the user to get to the destination), the platform 101 would alert the user automatically of the appointment.

As shown, a main menu 720 interface is provided by the STB 107a. According to one embodiment, a notification 721 can be integrated with the menu interface 720 or other programming guide menus; notification 121 relates to the above example of the impending flight to Osaka that may be missed, and thus, states “Flight to Osaka Departs in 3 hours!” Alternatively, or additionally, this notification can appear over content that is being shown over the STB 107a, according to one embodiment. At this point, the user may wish to cease watching television and prepare to drive to the airport because of poor traffic conditions.

Per main menu 720 interface, the user can be further prompted via a “Press OK to Launch” text 723 to launch a calendar application 725. Main menu 720 may be evoked by selecting an option within another interface or application (e.g., when navigating from a public screen to a user-specific screen, i.e., a private screen). As such, an executing device may require sufficient authentication information (e.g., username and password, etc.) to be input in order to access the functions of main menu 720.

As shown, interface (or screen) 720, providing a “Main Menu,” may include one or more interactive viewing panes, such as panes 727 and 729. In particular embodiments, the content of pane 729 may be dynamically updated to display various information related to actions conducted within pane 727, and vice versa. Pane 721 includes a listing of selectable entries corresponding to one or more features (or options) that may be provided via STB 107a. For example, entries can include: program guide functions, DVR options, marketplace (shopping) options, on-demand programming options (e.g., browsing or searching on-demand programming), media manager features, messaging and communications features, searching options, settings, help features, and the like. In certain embodiments, graphical elements may be provided to correspond to one or more of the entries, and may be displayed therewith.

One of ordinary skill in the art would recognize that the processes for providing automated appointment management described above may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a first appointment message from a first service provider system relating to a first appointment with a user;
receiving a second appointment message from a second service provider system relating to a second appointment with the user;
generating a first calendar entry in response to the first appointment message;
generating a second calendar entry in response to the second appointment message; and
retrieving user profile information corresponding to the user to determine one or more user devices that are specified to receive the calendar entries.

2. A method of claim 1, further comprising:
receiving a subscription request from each of the service provider systems to subscribe to an automated appointment service; and
verifying that each of the service provider systems is associated with a valid subscription in response to the respective received appointment messages.

3. A method of claim 1, further comprising:
executing a centralized calendar application; and
storing the first calendar entry and the second calendar entry in a database that is accessible by the centralized calendar application.

4. A method of claim 1, further comprising:
initiating transmission of the calendar entries to one or more user devices according to the user profile information,
wherein the user device is configured to locally execute a calendar application for receiving the calendar entries.

5. A method of claim 4, further comprising:
determining a notification criterion from the user profile;
determining whether the notification criterion is satisfied; and
if the notification criterion is satisfied, automatically generating, independently from the locally executed calendar application, a notification message for transmission to the user device based on either the first calendar entry or the second calendar entry.

6. A method of claim 1, wherein the first appointment message includes a code specified by the user, the method further comprising:
extracting the first appointment message to determine the code; and
correlating the code with the user.

7. A method of claim 6, wherein the code is designated as either one-time use, or multiple use.

8. A method of claim 1, wherein the user devices include either a mobile communication device, a computer, or a set-top box; and the first service provider system corresponds to either an airline service, a medical service, a food service, or a lodging service.

9. A method of claim 1, further comprising:
receiving a message to update or cancel the first calendar entry; and
initiating communication with the first service provider about the update or the cancellation of the first calendar entry.

10. An apparatus comprising:
a first communication interface configured to receive a first appointment message from a first service provider system relating to a first appointment with a user;
a second communication interface configured to receive a second appointment message from a second service provider system relating to a second appointment with the user;
a processor coupled to the communication interfaces and configured to generate a first calendar entry in response to the first appointment message, to generate a second calendar entry in response to the second appointment message, and to retrieve user profile information corresponding to the user to determine one or more user devices that are specified to receive the calendar entries.

11. An apparatus of claim 10, wherein the communication interfaces are further configured to receive, respectively, a subscription request from each of the service provider systems to subscribe to an automated appointment service,
wherein the processor is further configured to verify that each of the service provider systems is associated with a valid subscription in response to the respective received appointment messages.

12. An apparatus of claim 10, wherein the processor is further configured to execute a centralized calendar application, the apparatus further comprising:
a database that is accessible by the centralized calendar application and is configured to store the first calendar entry and the second calendar entry in.

13. An apparatus of claim 10, wherein the processor is further configured to initiate transmission of the calendar entries to one or more user devices according to the user profile information,
wherein the user device is configured to locally execute a calendar application for receiving the calendar entries.

14. An apparatus of claim 13, wherein the processor is further configured to determine a notification criterion from the user profile, to determine whether the notification criterion is satisfied, and if the notification criterion is satisfied to automatically generate, independently from the locally executed calendar application, a notification message for transmission to the user device based on either the first calendar entry or the second calendar entry.

15. An apparatus of claim 10, wherein the first appointment message includes a code specified by the user, and the processor is further configured to extract the first appointment message to determine the code, and to correlate the code with the user.

16. An apparatus of claim 15, wherein the code is designated as either one-time use, or multiple use.

17. An apparatus of claim 10, wherein the user devices include either a mobile communication device, a computer, or a set-top box, and the first service provider system corresponds to either an airline service, a medical service, a food service, or a lodging service.

18. An apparatus of claim 10, wherein the processor is further configured to receive a message to update or cancel the first calendar entry, and to initiate communication with the first service provider about the update or the cancellation of the first calendar entry

19. A computer-readable storage medium carrying one or more sequences of one or more instructions which, when executed by one or more processors, cause the one or more processors to at least perform the following:
receiving a first appointment message from a first service provider system relating to a first appointment with a user;
receiving a second appointment message from a second service provider system relating to a second appointment with the user;
generating a first calendar entry in response to the first appointment message;
generating a second calendar entry in response to the second appointment message; and
retrieving user profile information corresponding to the user to determine one or more user devices that are specified to receive the calendar entries.

20. A computer-readable storage medium of claim 19, wherein the one or more processors are caused to further perform the following:
receiving a subscription request from each of the service provider systems to subscribe to an automated appointment service; and
verifying that each of the service provider systems is associated with a valid subscription in response to the respective received appointment messages.
